(19) United States
(12) Patent Application Publication
(10) Pub. No.: US 2018/0019043 A1
(43) Pub. Date: Jan. 18, 2018

(54) SOFT MAGNETIC METAL POWDER AND DUST CORE

(71) Applicant: TDK CORPORATION, Tokyo (JP)

(72) Inventors: Koji MIURA, Tokyo (JP); Ryoma NAKAZAWA, Tokyo (JP); Katsushi YASUHARA, Tokyo (JP); Tomohisa MITOSE, Tokyo (JP)

(73) Assignee: TDK CORPORATION, Tokyo (JP)

(21) Appl. No.: 15/643,956

(22) Filed: Jul. 7, 2017

(30) Foreign Application Priority Data
Jul. 12, 2016 (JP) 2016-137862

(51) Int. Cl. H01F 1/147; C22C 38/10; B22F 9/08; H01F 3/08; C22C 38/02

(52) U.S. Cl. CPC H01F 1/14766; H01F 3/08; C22C 38/02; B22F 9/082; C22C 38/10; B22F 2301/35; B22F 2304/10; C22C 2202/02

(57) ABSTRACT

A soft magnetic metal powder includes a plurality of soft magnetic metal particles composed of an Fe—Co based alloy. The Fe—Co based alloy includes 0.50 mass % or more and 8.00 mass % or less of Co and a remaining part composed of Fe and an inevitable impurity. A soft magnetic metal powder includes a plurality of soft magnetic metal particles composed of an Fe—Co based alloy. The Fe—Co based alloy includes 0.50 mass % or more and 8.00 mass % or less of Co, 0.01 mass % or more and 8.00 mass % or less of Si, and a remaining part composed of Fe and an inevitable impurity. The present invention can provide a soft magnetic metal powder or so having a favorable corrosion resistance.

### BACKGROUND OF THE INVENTION

### 1. Field of the Invention

The present invention relates to a soft magnetic metal powder and a dust core.

### 2. Description of the Related Art

Coil type electronic devices, such as transformers, choke coils, and inductors, are known as electronic devices used for power supply circuit of various kinds of electronic apparatus for consumers and automobiles.

In the coil type electronic devices, a coil (wire) of electric conductor is configured to be arranged around or inside a magnetic body exhibiting predetermined magnetic properties. Various kinds of materials can be used as the magnetic body depending upon desired properties. In conventional coil type electronic devices, ferrite materials with high permeability and low power loss have been used as the magnetic body.

For corresponding to further downsizing and large current of the coil type electronic devices, a soft magnetic metal material whose saturated magnetic flux density is higher than that of the ferrite materials and DC superposition properties are favorable even under a high magnetic field has been recently used as a magnetic body. For example, a magnetic core as a magnetic body can be obtained by compressively pressing a soft magnetic metal powder containing soft magnetic metal particles.

Examples of the soft magnetic metal materials include pure iron and Fe—Si based alloys. These materials are metals whose main component is Fe and thus need to enhance their insulation property or corrosion resistance (especially, corrosion resistance for oxidation). To enhance insulation property or corrosion resistance, the soft magnetic metal particles have been conventionally provided with insulation films composed of organic substance or inorganic substance.

When the soft magnetic metal powder is pressed compressively, however, the films may be peeled due to deformation of the soft magnetic metal particles, friction with a die, or the like. As a result, there is a problem with decrease in insulation property and corrosion resistance of a dust core after being pressed compressively.

For example, Patent Document 1 discloses that insulation property is enhanced with soft magnetic metal particles configured by adding Co and element(s) of Al, Si, Cr, etc. to Fe.

Patent Document 2 discloses that corrosion resistance is improved with soft magnetic metal particles configured by adding Cr, Mn, and element(s) of Si, Al, etc. to Fe.

Patent Document 1: JP 2008-297622 A

Patent Document 2: JP 2003-160847 A

### SUMMARY OF THE INVENTION

The prevent invention has been achieved under such circumstances. It is an object of the invention to provide a soft magnetic metal powder or so having a favorable corrosion resistance.

The present inventors have studied corrosion resistance, especially corrosion resistance for oxidation, of a soft magnetic metal material composed of an alloy whose main component is iron. As a result, the present inventors have found that the soft magnetic metal material exhibits a favorable corrosion resistance by controlling a content of Co in a predetermined range in an oxidation environment containing moisture, such as an environment with high humidity, without depending upon Cr, which is normally used as an element for improvement in corrosion resistance. Then, the present invention has been achieved.

Furthermore, the present inventors have found that the metal material exhibits favorable soft magnetic properties and corrosion resistance by controlling a content of Si, in addition to Co, in a predetermined range. Then, the present invention has been achieved.

That is, a first aspect of the present invention is:

[1] A soft magnetic metal powder including a plurality of soft magnetic metal particles composed of an Fe—Co based alloy, wherein the Fe—Co based alloy includes:

0.50 mass % or more and 8.00 mass % or less of Co; and

a remaining part composed of Fe and an inevitable impurity.

The above soft magnetic metal powder can exhibit a favorable corrosion resistance for oxidation even in an oxidation environment containing moisture without depending upon Cr. Moreover, Co is an element that exhibits ferromagnetism at room temperature, and predetermined magnetic properties can be thus demonstrated with respect to saturation magnetization or so, which deteriorates when containing Cr.

[2] The soft magnetic metal powder according to [1] includes 1.00 mass % or more and 4.00 mass % or less of Co.

When the content of Co in the Fe—Co based alloy is in the above range, the above effects can be further improved.

[3] The soft magnetic metal powder according to [1] or [2], wherein the Fe—Co based alloy further includes 0.50 mass % or more and 8.00 mass % or less of Si.

When the content of Si in the above soft magnetic metal powder is in the above range, coercivity can be reduced while predetermined magnetic properties can be demonstrated with respect to saturation magnetization or so.

A second aspect of the present invention is:

a dust core composed of the soft magnetic metal powder according to any of [1] to [3].

The above pressed magnetic core is composed using the above soft magnetic metal powder, and thus has favorable corrosion resistance for oxidation and further obtains predetermined magnetic properties with respect to DC superposition properties or so. Furthermore, when the dust core is composed using the soft magnetic metal powder containing Si, magnetic properties with respect to hysteresis loss can also become favorable.

### BRIEF DESCRIPTION OF THE DRAWINGS

FIG. 1 is a graph showing a relation between a content of Co and corrosion resistance of a soft magnetic metal powder in Examples and Comparative Examples of the present invention.

FIG. 2 is a graph showing a relation between a content of Co and corrosion resistance of a dust core in Examples and Comparative Examples of the present invention.

### DESCRIPTION OF THE PREFERRED EMBODIMENTS

Hereinafter, the present invention will be described in detail in the following order based on a specific embodiment.

1. Soft magnetic metal powder
2. Dust core
3. Manufacturing method of soft magnetic metal powder
4. Manufacturing method of dust core
5. Effects of present embodiment

### 1. Soft Magnetic Metal Powder

A soft magnetic metal powder according to the present embodiment is an aggregation of a plurality of soft magnetic metal particles. In the present embodiment, the soft magnetic metal particles are composed of an Fe—Co based alloy. As a first aspect, the Fe—Co based alloy includes an Fe—Co alloy containing 0.50 mass % or more and 8.00 mass % or less of Co and a remaining part composed of Fe and inevitable impurities.

Since the Fe—Co alloy contains Co, a thin oxide film containing Co is formed on particle surfaces, and corrosion is considered to be prevented from progressing.

Thus, the soft magnetic metal powder containing the soft magnetic metal particles composed of the Fe—Co alloy can improve corrosion resistance in an oxidation environment containing moisture, and further demonstrate predetermined magnetic properties with respect to saturation magnetization or so. For example, it is consequently possible to favorably prevent generation of rust (oxidation film) at the time of manufacture of the powder and oxidation of the soft magnetic metal powder in a humid environment such as the outside. Furthermore, when a magnetic core, such as a dust core, is constituted using the soft magnetic metal powder, it is possible to obtain a coil type electronic device or so having a favorable corrosion resistance for oxidation and predetermined magnetic properties.

In the Fe—Co alloy, a content of Co is 0.50 mass % or more, preferably 1.00 mass % or more. When a content of Co is too small, corrosion resistance tends to deteriorate.

In the Fe—Co alloy, a content of Co is 8.00 mass % or less, preferably 4.00 mass % or less. When a content of Co is too large, corrosion resistance is favorable, but coercivity is too high, and the Fe—Co alloy tends to be unfavorable as a raw material of a magnetic body of coil type electronic devices or so.

As a second aspect, the Fe—Co based alloy according to the present embodiment includes an Fe—Co—Si alloy containing 0.50 mass % or more and 8.00 mass % or less of Co, 0.50 mass % or more and 8.00 mass % or less of Si, and a remaining part composed of Fe and inevitable impurities. Since the Fe—Co—Si alloy also contains Co and Si, a thin oxide films containing Co or Co and Si is formed on particle surfaces, and corrosion is considered to be prevented from progressing.

Thus, as with the Fe—Co alloy, the soft magnetic metal powder containing the soft magnetic metal particles composed of the Fe—Co—Si alloy can have a favorable corrosion resistance in an oxidation environment containing moisture, and can demonstrate predetermined magnetic properties with respect to saturation magnetization or so. For example, it is consequently possible to favorably prevent generation of rust (oxidation film) at the time of manufacture of the powder and oxidation of the soft magnetic metal powder in a humid environment such as the outside. Furthermore, when a magnetic core, such as a dust core, is constituted using the soft magnetic metal powder, it is possible to obtain a coil type electronic device or so having a favorable corrosion resistance for oxidation and predetermined magnetic properties. In particular, the soft magnetic metal powder containing the soft magnetic metal particles composed of the Fe—Co—Si alloy tends to have magnetic properties, such as saturation magnetization, that are slightly inferior to those of the soft magnetic metal powder containing the soft magnetic metal particles composed of the Fe—Co alloy, but tends to have a coercivity that is smaller than that of the soft magnetic metal powder containing the soft magnetic metal particles composed of the Fe—Co alloy.

In the Fe—Co—Si alloy, a content of Co is 0.50 mass % or more, preferably 1.00 mass % or more. When a content of Co is too small, corrosion resistance tends to deteriorate.

In the Fe—Co—Si alloy, a content of Co is 8.00 mass % or less, preferably 4.00 mass % or less. When a content of Co is too large, corrosion resistance is favorable, but coercivity is too high, and the Fe—Co—Si alloy tends to be unfavorable as a raw material of a magnetic body of coil type electronic devices or so.

In the Fe—Co—Si alloy, a content of Si is 0.50 mass % or more, preferably 3.00 mass % or more. The Fe—Co—Si alloy can reduce coercivity by containing Si.

In the Fe—Co—Si alloy, a content of Si is 8.00 mass % or less, preferably 6.55 mass % or less. When a content of Si is too large, an effect on reduction in coercivity is increased, but magnetic properties, such as saturation magnetization, tend to deteriorate, and the Fe—Co—Si alloy tends to be unfavorable as a raw material of a magnetic body of coil type electronic devices or so.

The above Fe—Co based alloy (Fe—Co alloy and Fe—Co—Si alloy) normally contains inevitable impurities. The inevitable impurities are in a raw material of an object (in the present embodiment, the soft magnetic metal powder) or enter in the manufacturing process or so. The inevitable impurities are trace constituents remaining in the object and are contained in a range where no effect is given to predetermined properties of the object.

Thus, the inevitable impurities should be removed from a viewpoint of purity of the object, but a predetermined amount of the inevitable impurities is acceptable to remain in the object in view of a balance between a cost for the removal or so and desired properties.

In the present embodiment, the inevitable impurities include C, P, S, N, 0, etc.

In the Fe—Co based alloy according to the present embodiment, an additive element other than Si includes Al or so, for example, but these elements worsen predetermined magnetic properties with respect to saturation magnetization or so and are thus unfavorable.

The soft magnetic metal powder according to the present embodiment has an average particle size (D50) determined by its use. In the present embodiment, the soft magnetic metal powder preferably has an average particle size (D50) conforming to a range of 1 to 100 When the soft magnetic metal powder has an average particle size (D50) conforming to the range, it becomes easy to maintain a sufficient pressing property or predetermined magnetic properties. The average particle size is measured by any method, but is preferably measured by a laser diffraction scattering method. Incidentally, the soft magnetic metal particles constituting the soft magnetic metal powder have any shape.

### 2. Dust Core

A dust core according to the present embodiment may be any core composed of the above-mentioned soft magnetic metal powder and formed with a predetermined shape. In the present embodiment, the dust core contains the soft magnetic metal powder and a binding agent, and is fixed to a predetermined shape by binding each of the soft magnetic metal particles constituting the soft magnetic metal powder via the binding agent. The dust core may be composed of a mixed powder of the above-mentioned soft magnetic metal powder and another magnetic powder and formed into a predetermined shape.

The dust core is composed of the above-mentioned soft magnetic metal powder, and thus has a favorable corrosion resistance for oxidation and demonstrates predetermined magnetic properties with respect to DC superposition properties or so.

### 3. Manufacturing Method of Soft Magnetic Metal Powder

Next, a manufacturing method of the above soft magnetic metal powder will be described. In the present embodiment, the soft magnetic metal powder can be obtained by a similar method to a known manufacturing method of soft magnetic metal powders. Specifically, the soft magnetic metal powder can be manufactured using a gas atomizing method, a water atomizing method, a rotating disk method, or the like. In particular, a gas atomizing method of these methods is preferable from a viewpoint of easily obtaining a soft magnetic metal powder having desired magnetic properties.

As described above, the soft magnetic metal powder according to the present embodiment has a favorable corrosion resistance even in an oxidation environment containing moisture, and it is thus possible to effectively prevent generation of rust even at the time of manufacture of the powder by a water atomizing method.

In the water atomizing method or the gas atomizing method, a molten raw material (molten metal) is supplied as a linear and continuous fluid via a nozzle provided in a bottom of a crucible, the supplied molten metal is made into droplets by being sprayed with a high-pressure water or gas and is rapidly cooled, and a fine powder is obtained.

In the present embodiment, the soft magnetic metal powder according to the present embodiment can be manufactured by melting a raw material of Fe, a raw material of Co, and a raw material of Si and turning this molten material into a fine powder by the water atomizing method or the gas atomizing method.

### 4. Manufacturing Method of Dust Core

In the present embodiment, the dust core is manufactured using the soft magnetic metal powder thus obtained. The magnetic core is manufactured by any method, and can be manufactured by a known method. First, the soft magnetic metal powder and a known binder as a binding agent are mixed, and a mixture is obtained. If necessary, the obtained mixture may be turned into a granulated powder. Then, the mixture or the granulated powder is filled in a die and pressed compressively, and a green compact having a shape of a magnetic body (magnetic core) to be manufactured is obtained. The obtained green compact is subjected to a heat treatment, and a dust core having a predetermined shape and fixed soft magnetic metal particles is obtained. The obtained dust core is wound by a wire with a predetermined number of times, and a coil type electronic device, such as an inductor, is obtained.

The above mixture or the granulated powder and an air core coil formed by winding a wire with a predetermined number of times may be filled in a die and pressed compressively, and a green compact where the coil is embedded may be obtained. The obtained green compact is subjected to a heat treatment, and a dust core having a predetermined shape and containing the coil is obtained. The coil is embedded in the dust core, and the dust core thus functions as a coil type electronic device such as an inductor.

### 5. Effects of Present Embodiment

In the present embodiment explained in (1) to (4) mentioned above, the soft magnetic metal particles contained in the soft magnetic metal powder are composed of the Fe—Co alloy particles or the Fe—Co—Si alloy particles, and the contents of Co and Si are in the predetermined ranges.

In the soft magnetic metal powder according to the present embodiment, corrosion resistance for oxidation can be thus improved without depending upon Cr, which is normally used as an element for improvement in corrosion resistance. It is then possible to prevent oxidation (generation of rust) of the powder at the time of manufacture thereof by a water atomizing method. The oxidation (generation of rust) of the powder can be prevented even in a humid environment containing moisture. In addition, the soft magnetic metal powder according to the present embodiment does not contain Cr, which worsens magnetic properties such as saturation magnetization, but contains Co, which exhibits ferromagnetism at room temperature, and can thus improve magnetic properties such as saturation magnetization.

In addition to Co, the soft magnetic metal powder according to the present embodiment contains a predetermined amount of Si, and thus can reduce coercivity while preventing decrease in saturation magnetization or so and maintaining predetermined magnetic properties.

The dust core according to the present embodiment is composed of the soft magnetic metal powder according to the present embodiment, and thus has a favorable corrosion resistance. Even in a humid environment containing moisture, it is thus possible to prevent generation of rust on the surface of the magnetic core and deterioration of magnetic properties of the magnetic core and demonstrate predetermined magnetic properties with respect to DC superposition properties or so. Since coercivity is reduced in the dust core composed of the soft magnetic metal powder containing the Fe—Co—Si alloy particles, hysteresis loss can be reduced.

The embodiment of the present invention is accordingly described, but the present invention is not limited to the above embodiment, and may be changed to various embodiments within the scope of the present invention.

### EXAMPLES

Hereinafter, the invention will be explained in more detail using examples, but the present invention is not limited to the examples.

### Experimental Example 1

First, ingots, chunks (blocks), or shots (grains) of a simple substance of Fe and a simple substance of Co were prepared as raw materials. Next, the raw materials were mixed and housed in a crucible arranged in a gas atomizing apparatus. Then, in an inert atmosphere, the crucible was heated to 1600° C. or more by high-frequency induction using a work coil arranged outside the crucible, and the ingots, chunks, or shots in the crucible were molten and mixed to obtain molten metals.

Next, the molten metals supplied from a nozzle arranged in the crucible so that a linear and continuous fluid was formed were collided with a gas flow of 1 to 10 MPa to be droplets and rapidly cooled at the same time, whereby soft magnetic metal powders composed of Fe—Co alloy particles were manufactured.

The obtained soft magnetic metal powders were sieved to adjust their particle size, and soft magnetic metal powders whose average particle size were 25 μm were obtained.

The obtained soft magnetic metal powders were pelletized and subjected to composition analysis by a fluorescent X-ray analysis method. As a result, it was found that the obtained soft magnetic metal powders had compositions shown in Table 1.

Next, the obtained soft magnetic metal powders were evaluated with respect to magnetic properties and corrosion resistance. The magnetic properties were measured with respect to saturation magnetization and coercivity. First, the saturation magnetization was measured using a vibration sample type magnetometer (a VSM manufactured by TAMAKAWA CO., LTD.). In the present example, the saturation magnetization is preferably larger. Table 1 shows the results.

20 mg of the powders was placed in a plastic case of φ 6 mm×5 mm, fixed after a paraffin was molten and solidified therein, and measured with respect to coercivity using a coercivity meter (K-HC1000 type) manufactured by Tohoku Steel Co., Ltd. The coercivity was measured in a magnetic field of 150 kA/m. The coercivity is also affected by a particle size of the powders, and thus has no need to be evaluated by absolute values. In the present example, however, the coercivity is preferably closer to the coercivity of the pure iron (Comparative Example la), and is acceptable to be about 1300 A/m. Table 1 shows the results.

The corrosion resistance was evaluated in the following manner. First, the obtained soft magnetic metal powders were immersed into a 5% saline solution and maintained at 35° C. for 24 hours as a test. The soft magnetic metal powders after the test were cleaned with an ion exchange water, dried, and then evaluated with respect to corrosion resistance by calculating weight change before and after the test due to rust (oxidation). Table 1 shows the results. In Table 1, a soft magnetic metal powder having a weight change rate of 0.300% or more is represented as “x (bad)” and determined as having a low corrosion resistance, a soft magnetic metal powder having a weight change rate of 0.250% or more and less than 0.300% is represented as “Δ (fair)” and determined as having a corrosion resistance, a soft magnetic metal powder having a weight change rate of 0.150% or more and less than 0.250% is represented as “◯ (good)” and determined as having a good corrosion resistance, and a soft magnetic metal powder having a weight change rate of less than 0.150% is represented as “⊚ (excellent)” and determined as having an extremely good corrosion resistance.

Next, a dust core was evaluated. An epoxy resin and an imide resin were added to an acetone and turned into a solution so that a total amount of the epoxy resin as a thermosetting resin and the imide resin as a curing agent was set to 4 mass % with respect to 100 mass % of the obtained soft magnetic metal powder, and the solution and the soft magnetic metal powder were mixed. After this, a granulation obtained by volatilizing the acetone was sized by a mesh of 355 μm, filled in a die with a toroidal shape having an outer diameter of 17.5 mm and an inner diameter of 11.0 mm, and pressed at a pressure of 588 MPa, whereby a green compact of a dust core was obtained. This green compact had a weight of 5 g. The manufactured green compact of a dust core was subjected to a thermosetting treatment at 180° C. for 3 hours in the air.

The dust core after the thermosetting treatment was wound by wires (primary wire: 50 ts, secondary wire: 10 ts) and measured with respect to a magnetic flux density in a magnetic field of 8 kA/m using a DC magnetization measurement device (METRON SK110). In the present example, the magnetic flux density is preferably larger. Table 2 shows the results. DC superposition properties were measured using an LCR meter (4284A manufactured by Agilent Technologies, Inc.) and a DC bias power supply (42841A manufactured by Agilent Technologies, Inc.). Table 2 shows the results. In Table 2, an initial permeability of the DC superposition properties is described as μ₀, and a magnetic field where μ₀ decreases to 80% is described as H (μ₀×0.8).

Coercivity of the dust cores was measured in the same manner as the soft magnetic metal powders using a coercivity meter (K-HC1000 type) manufactured by Tohoku Steel Co., Ltd. Table 2 shows the results.

The corrosion resistance was evaluated in the following manner. First, the green compacts of the obtained soft magnetic metal powders were sprayed with a 5% saline solution and maintained at 35° C. for 24 hours as a test. The soft magnetic metal powders after the test were cleaned with an ion exchange water, dried, and observed with respect to their rusting state by an optical microscope (50 times). In an optional visual field, a mark was put on an area considered to be a rust, and an area ratio occupied by the rust was calculated using a commercially available image analysis software (Mac View manufactured by Mountech Co., Ltd.). Table 2 shows the results. In Table 2, a dust core having an area ratio occupied by the rust of 10.0% or more is represented as “x (bad)” and determined as having a low corrosion resistance, a dust core having an area ratio occupied by the rust of 8.0% or more and less than 10.0% is represented as “Δ (fair)” and determined as having a corrosion resistance, a dust core having an area ratio occupied by the rust of 5.0% or more and less than 8.0% is represented as “◯ (good)” and determined as having a good corrosion resistance, and a dust core having an area ratio occupied by the rust of less than 5.0% is represented as “⊚(excellent)” and determined as having an extremely good corrosion resistance.

TABLE 1

| | | | Properties | | | |
|---|---|---|---|---|---|---|
| | | | Magnetic properties | | | |
| | | | Saturation | | Corrosion resistance | |
| | Composition | | magnetization | | Weight | Determination |
| | Fe | Co | of powder | Coercivity | change rate | of corrosion |
| | [mass %] | [mass %] | [emu/g] | [A/m] | [%] | resistance |
| Comp. Ex. 1a | 100 | 0.00 | 215.0 | 762 | 0.714 | X (bad) |
| Comp. Ex. 2a | bal. | 0.25 | 215.3 | 779 | 0.651 | X (bad) |
| Example 1a | bal. | 0.51 | 215.7 | 798 | 0.289 | Δ(fair) |
| Example 2a | bal. | 1.03 | 216.4 | 834 | 0.212 | ◯(good) |
| Example 3a | bal. | 1.40 | 216.9 | 860 | 0.148 | ⊚(excellent) |
| Example 4a | bal. | 2.01 | 217.7 | 902 | 0.120 | ⊚(excellent) |
| Example 5a | bal. | 2.99 | 219.0 | 971 | 0.115 | ⊚(excellent) |
| Example 6a | bal. | 3.98 | 220.3 | 1040 | 0.110 | ⊚(excellent) |
| Example 7a | bal. | 6.01 | 223.0 | 1182 | 0.100 | ⊚(excellent) |
| Example 8a | bal. | 7.82 | 225.5 | 1289 | 0.103 | ⊚(excellent) |
| Comp. Ex. 3a | bal. | 8.23 | 225.9 | 1942 | 0.105 | ⊚(excellent) |
| Comp. Ex. 4a | bal. | Cr = 2.0 mass % | 176.4 | 648 | 0.453 | X (bad) |
| | | Si = 4.5 mass % | | | | |
| Comp. Ex. 5a | bal. | Cr = 5.0 mass % | 171.1 | 650 | 0.052 | ⊚(excellent) |
| | | Si = 4.5 mass % | | | | |

TABLE 2

| | | | Properties | | | | | |
|---|---|---|---|---|---|---|---|---|
| | | | Magnetic properties | | | | | |
| | | | Magnetic flux | | | DC | | |
| | | | density of | | DC | superposition | Corrosion resistance | |
| | Composition | | pressed powder | | superposition | property | Area ratio | Determination |
| | Fe | Co | [T] | Coercivity | property | H(μ₀ × 0.8) | of rust | of corrosion |
| | [mass %] | [mass %] | (at 8000 A/m) | [A/m] | μ₀ | [A/m] | [%] | resistance |
| Comp. Ex. 1b | 100 | 0.00 | 1.06 | 914 | 50.8 | 8513 | 51.4 | X (bad) |
| Comp. Ex. 2b | bal. | 0.25 | 1.07 | 935 | 50.8 | 8526 | 45.1 | X (bad) |
| Example 1b | bal. | 0.51 | 1.07 | 957 | 50.8 | 8540 | 9.9 | Δ(fair) |
| Example 2b | bal. | 1.03 | 1.07 | 1001 | 50.7 | 8568 | 6.2 | ◯(good) |
| Example 3b | bal. | 1.40 | 1.07 | 1032 | 50.7 | 8587 | 4.8 | ⊚(excellent) |
| Example 4b | bal. | 2.01 | 1.08 | 1083 | 50.6 | 8619 | 4.0 | ⊚(excellent) |
| Example 5b | bal. | 2.99 | 1.08 | 1165 | 50.6 | 8671 | 3.5 | ⊚(excellent) |
| Example 6b | bal. | 3.98 | 1.09 | 1248 | 50.5 | 8724 | 3.0 | ⊚(excellent) |
| Example 7b | bal. | 6.01 | 1.10 | 1419 | 50.4 | 8831 | 2.8 | ⊚(excellent) |
| Example 8b | bal. | 7.82 | 1.12 | 1547 | 50.4 | 8927 | 2.7 | ⊚(excellent) |
| Comp. Ex. 3b | bal. | 8.23 | 1.12 | 2330 | 50.2 | 8944 | 2.5 | ⊚(excellent) |
| Comp. Ex. 4b | bal. | Cr = 2.0 mass % | 0.84 | 1069 | 50.6 | 6969 | 25.3 | X (bad) |
| | | Si = 4.5 mass % | | | | | | |
| Comp. Ex. 5b | bal. | Cr = 5.0 mass % | 0.81 | 1073 | 50.6 | 6771 | 1.6 | ⊚(excellent) |
| | | Si = 4.5 mass % | | | | | | |

Table 1 shows that a favorable corrosion resistance was obtained when the content of Co in the Fe—Co alloy was in the above-mentioned range. Table 1 also shows that favorable magnetic properties were obtained when the content of Co in the Fe—Co alloy was in the above-mentioned range.

On the other hand, it was confirmed that when the content of Co was too small, corrosion resistance tended to deteriorate. It was also confirmed that containing too much Co was unfavorable because coercivity became large while an improvement effect on corrosion resistance tended to be saturated.

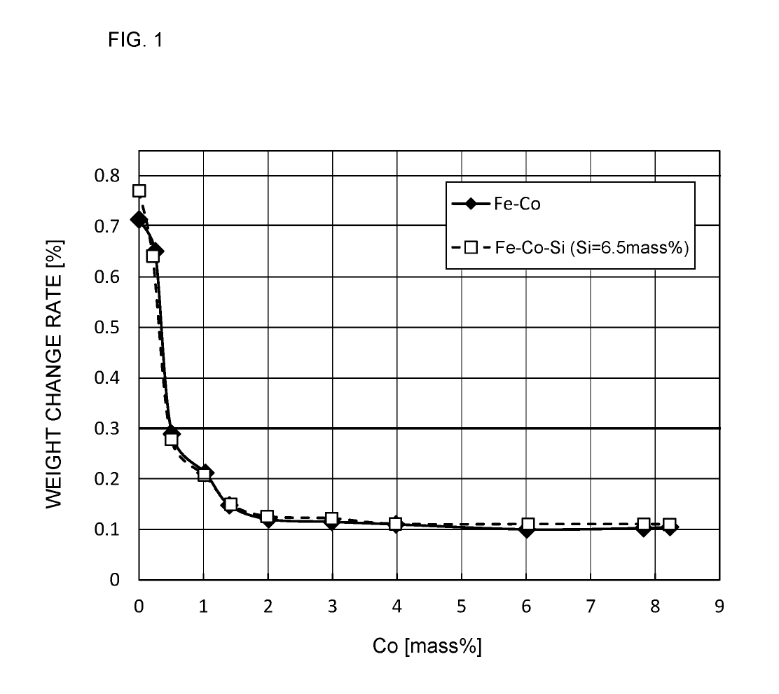

The above tendency is also clear from FIG. 1, which is a graph showing a relation between a content of Co and corrosion resistance of the soft magnetic metal powder. That is, FIG. 1 shows that corrosion resistance becomes more favorable as the content of Co increases.

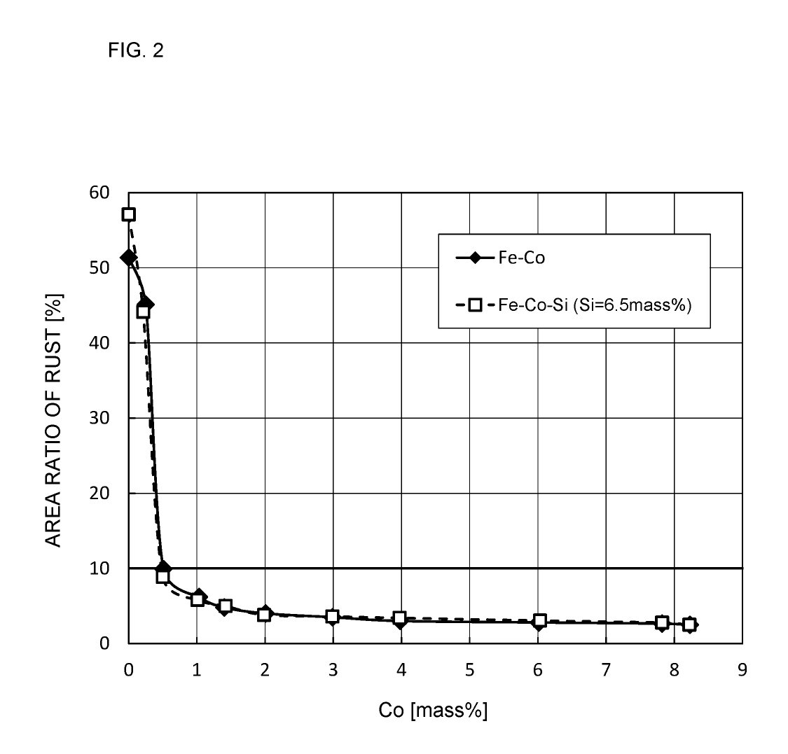

Table 2 shows that the dust cores also had favorable corrosion resistance and magnetic properties similarly to the powders in Table 1. As with FIG. 1, this tendency is also clear from FIG. 2, which is a graph showing a relation between a content of Co and corrosion resistance of the soft magnetic metal powder.

### Experimental Example 2

Powder samples were manufactured in the same manner as Experimental Example 1 and evaluated with respect to composition and powder property in the same manner as Experimental Example 1, except for adding a simple substance of Fe and a simple substance of Co as raw materials and having an Fe—Co—Si alloy with a simple substance of Si. Table 3 shows the results.

Samples of dust cores were manufactured in the same manner as Experimental Example 1 using soft magnetic metal powders of the Fe—Co—Si alloys manufactured in the above, and were evaluated with respect to magnetic core property in the same manner as Experimental Example 1. Table 4 shows the results.

TABLE 3

| | | | | Properties | | | |
|---|---|---|---|---|---|---|---|
| | | | | Magnetic properties | | | |
| | | | | Saturation | | Corrosion resistance | |
| | Composition | | | magnetization | | Weight | Determination |
| | Fe | Co | Si | of powder | Coercivity | change rate | of corrosion |
| | [mass %] | [mass %] | [mass %] | [emu/g] | [A/m] | [%] | resistance |
| Comp. Ex. 11a | bal. | 0.00 | 0.52 | 213.8 | 738 | 0.695 | X (bad) |
| Comp. Ex. 12a | bal. | 0.25 | 0.57 | 213.8 | 755 | 0.649 | X (bad) |
| Example 11a | bal. | 0.53 | 0.55 | 214.1 | 773 | 0.289 | Δ(fair) |
| Example 12a | bal. | 1.01 | 0.55 | 214.5 | 808 | 0.212 | ◯(good) |
| Example 13a | bal. | 1.40 | 0.51 | 215.2 | 833 | 0.142 | ⊚(excellent) |
| Example 14a | bal. | 2.03 | 0.52 | 215.7 | 874 | 0.123 | ⊚(excellent) |
| Example 15a | bal. | 3.05 | 0.54 | 216.5 | 941 | 0.116 | ⊚(excellent) |
| Example 16a | bal. | 3.99 | 0.55 | 217.8 | 1008 | 0.110 | ⊚(excellent) |
| Example 17a | bal. | 6.05 | 0.55 | 219.1 | 1145 | 0.108 | ⊚(excellent) |
| Example 18a | bal. | 7.88 | 0.53 | 221.8 | 1249 | 0.107 | ⊚(excellent) |
| Comp. Ex. 13a | bal. | 8.23 | 0.54 | 224.2 | 1881 | 0.108 | ⊚(excellent) |
| Comp. Ex. 21a | bal. | 0.00 | 3.02 | 208.0 | 624 | 0.671 | X (bad) |
| Comp. Ex. 22a | bal. | 0.27 | 2.95 | 208.3 | 638 | 0.651 | X (bad) |
| Example 21a | bal. | 0.54 | 3.03 | 208.7 | 653 | 0.289 | Δ(fair) |
| Example 22a | bal. | 1.02 | 2.97 | 209.3 | 683 | 0.212 | ◯(good) |
| Example 23a | bal. | 1.40 | 3.02 | 209.8 | 704 | 0.148 | ⊚(excellent) |
| Example 24a | bal. | 1.98 | 3.02 | 210.6 | 739 | 0.120 | ⊚(excellent) |
| Example 25a | bal. | 3.04 | 3.02 | 211.9 | 795 | 0.115 | ⊚(excellent) |
| Example 26a | bal. | 4.03 | 2.96 | 213.2 | 852 | 0.109 | ⊚(excellent) |
| Example 27a | bal. | 5.99 | 3.03 | 215.8 | 968 | 0.105 | ⊚(excellent) |
| Example 28a | bal. | 7.81 | 3.01 | 217.0 | 1279 | 0.103 | ⊚(excellent) |
| Comp. Ex. 23a | bal. | 8.22 | 3.03 | 218.5 | 1590 | 0.100 | ⊚(excellent) |
| Comp. Ex. 31a | bal. | 0.00 | 4.28 | 203.0 | 557 | 0.648 | X (bad) |
| Comp. Ex. 32a | bal. | 0.26 | 4.31 | 203.3 | 570 | 0.633 | X (bad) |
| Example 31a | bal. | 0.51 | 4.31 | 203.6 | 583 | 0.289 | Δ(fair) |
| Example 32a | bal. | 1.01 | 4.29 | 204.3 | 610 | 0.212 | ◯(good) |
| Example 33a | bal. | 1.36 | 4.33 | 204.8 | 629 | 0.148 | ⊚(excellent) |
| Example 34a | bal. | 2.00 | 4.28 | 205.5 | 660 | 0.120 | ⊚(excellent) |
| Example 35a | bal. | 3.00 | 4.27 | 206.8 | 710 | 0.115 | ⊚(excellent) |
| Example 36a | bal. | 3.96 | 4.25 | 208.0 | 760 | 0.110 | ⊚(excellent) |
| Example 37a | bal. | 6.03 | 4.25 | 210.6 | 864 | 0.100 | ⊚(excellent) |
| Example 38a | bal. | 7.82 | 4.24 | 212.2 | 1142 | 0.100 | ⊚(excellent) |
| Comp. Ex. 33a | bal. | 8.20 | 4.25 | 213.3 | 1420 | 0.099 | ⊚(excellent) |
| Comp. Ex. 41a | bal. | 0.00 | 6.49 | 180.0 | 502 | 0.771 | X (bad) |
| Comp. Ex. 42a | bal. | 0.21 | 6.52 | 180.3 | 514 | 0.641 | X (bad) |
| Example 41a | bal. | 0.50 | 6.50 | 180.6 | 525 | 0.279 | Δ(fair) |
| Example 42a | bal. | 1.01 | 6.48 | 181.2 | 549 | 0.208 | ◯(good) |
| Example 43a | bal. | 1.42 | 6.54 | 181.6 | 566 | 0.149 | ⊚(excellent) |
| Example 44a | bal. | 1.98 | 6.53 | 182.3 | 595 | 0.126 | ⊚(excellent) |
| Example 45a | bal. | 2.98 | 6.51 | 183.3 | 640 | 0.122 | ⊚(excellent) |
| Example 46a | bal. | 3.97 | 6.46 | 184.5 | 685 | 0.111 | ⊚(excellent) |
| Example 47a | bal. | 6.03 | 6.45 | 186.7 | 779 | 0.111 | ⊚(excellent) |
| Example 48a | bal. | 7.82 | 6.48 | 188.0 | 1049 | 0.110 | ⊚(excellent) |
| Comp. Ex. 43a | bal. | 8.22 | 6.51 | 189.1 | 1279 | 0.110 | ⊚(excellent) |
| Comp. Ex. 51a | bal. | 0.00 | 7.39 | 177.3 | 512 | 0.779 | X (bad) |
| Comp. Ex. 52a | bal. | 0.23 | 7.40 | 177.6 | 524 | 0.643 | X (bad) |
| Example 51a | bal. | 0.50 | 7.39 | 177.9 | 536 | 0.288 | Δ(fair) |
| Example 52a | bal. | 1.03 | 7.37 | 178.4 | 561 | 0.223 | ◯(good) |
| Example 53a | bal. | 1.40 | 7.44 | 178.8 | 578 | 0.149 | ⊚(excellent) |
| Example 54a | bal. | 1.97 | 7.40 | 179.5 | 607 | 0.137 | ⊚(excellent) |
| Example 55a | bal. | 2.98 | 7.38 | 180.6 | 653 | 0.126 | ⊚(excellent) |
| Example 56a | bal. | 3.97 | 7.39 | 181.7 | 699 | 0.110 | ⊚(excellent) |
| Example 57a | bal. | 6.04 | 7.38 | 183.9 | 795 | 0.108 | ⊚(excellent) |
| Example 58a | bal. | 7.82 | 7.39 | 185.2 | 1060 | 0.107 | ⊚(excellent) |
| Comp. Ex. 53a | bal. | 8.12 | 7.40 | 186.3 | 1326 | 0.106 | ⊚(excellent) |
| Comp. Ex. 61a | bal. | 0.00 | 8.28 | 161.6 | 522 | 0.787 | X (bad) |
| Comp. Ex. 62a | bal. | 0.25 | 8.28 | 161.8 | 534 | 0.645 | X (bad) |
| Comp. Ex. 63a | bal. | 0.50 | 8.27 | 162.1 | 547 | 0.297 | Δ(fair) |
| Comp. Ex. 64a | bal. | 1.04 | 8.26 | 162.6 | 572 | 0.238 | ◯(good) |
| Comp. Ex. 65a | bal. | 1.37 | 8.34 | 163.0 | 590 | 0.173 | ◯(good) |
| Comp. Ex. 66a | bal. | 1.96 | 8.27 | 163.6 | 619 | 0.148 | ⊚(excellent) |
| Comp. Ex. 67a | bal. | 2.97 | 8.25 | 164.6 | 666 | 0.131 | ⊚(excellent) |
| Comp. Ex. 68a | bal. | 3.96 | 8.32 | 165.6 | 713 | 0.109 | ⊚(excellent) |
| Comp. Ex. 69a | bal. | 6.05 | 8.31 | 167.6 | 810 | 0.105 | ⊚(excellent) |
| Comp. Ex. 70a | bal. | 7.82 | 8.30 | 168.8 | 1071 | 0.103 | ⊚(excellent) |
| Comp. Ex. 71a | bal. | 8.21 | 8.30 | 169.8 | 1331 | 0.101 | ⊚(excellent) |

TABLE 4

| | | | | Properties | | | | | |
|---|---|---|---|---|---|---|---|---|---|
| | | | | Magnetic properties | | | | | |
| | | | | | | | DC | | |
| | | | | Magnetic flux | | DC | superposition | Corrosion resistance | |
| | Composition | | | density of pressed | | superposition | property | Area ratio | Determination of |
| | Fe | Co | Si | powder[T] | Coercivity | property | H(μ₀ × 0.8) | of rust | corrosion |
| | [mass %] | [mass %] | [mass %] | (at 8000 A/m) | [A/m] | μ₀ | [A/m] | [%] | resistance |
| Comp. Ex. 11b | bal. | 0.00 | 0.52 | 1.03 | 886 | 50.8 | 8513 | 49.2 | X (bad) |
| Comp. Ex. 12b | bal. | 0.25 | 0.57 | 1.03 | 906 | 50.8 | 8207 | 45.1 | X (bad) |
| Example 11b | bal. | 0.53 | 0.55 | 1.03 | 927 | 50.8 | 8478 | 9.9 | Δ(fair) |
| Example 12b | bal. | 1.01 | 0.55 | 1.03 | 970 | 50.7 | 8492 | 6.2 | ◯(good) |
| Example 13b | bal. | 1.40 | 0.51 | 1.03 | 1000 | 50.7 | 8520 | 4.8 | ⊚(excellent) |
| Example 14b | bal. | 2.03 | 0.52 | 1.04 | 1049 | 50.6 | 8539 | 4.0 | ⊚(excellent) |
| Example 15b | bal. | 3.05 | 0.54 | 1.04 | 1129 | 50.6 | 8571 | 3.5 | ⊚(excellent) |
| Example 16b | bal. | 3.99 | 0.55 | 1.05 | 1209 | 50.5 | 8623 | 3.0 | ⊚(excellent) |
| Example 17b | bal. | 6.05 | 0.55 | 1.05 | 1374 | 50.4 | 8675 | 2.7 | ⊚(excellent) |
| Example 18b | bal. | 7.88 | 0.53 | 1.06 | 1499 | 50.4 | 8782 | 2.6 | ⊚(excellent) |
| Comp. Ex. 13b | bal. | 8.23 | 0.54 | 1.08 | 2258 | 50.2 | 8877 | 2.5 | ⊚(excellent) |
| Comp. Ex. 21b | bal. | 0.00 | 3.02 | 1.00 | 767 | 51.0 | 8236 | 47.1 | X (bad) |
| Comp. Ex. 22b | bal. | 0.27 | 2.95 | 1.00 | 785 | 51.0 | 8249 | 45.1 | X (bad) |
| Example 21b | bal. | 0.54 | 3.03 | 1.00 | 803 | 50.9 | 8262 | 9.9 | Δ(fair) |
| Example 22b | bal. | 1.02 | 2.97 | 1.00 | 840 | 50.9 | 8289 | 6.2 | ◯(good) |
| Example 23b | bal. | 1.40 | 3.02 | 1.01 | 866 | 50.9 | 8308 | 4.8 | ⊚(excellent) |
| Example 24b | bal. | 1.98 | 3.02 | 1.01 | 909 | 50.8 | 8339 | 4.0 | ⊚(excellent) |
| Example 25b | bal. | 3.04 | 3.02 | 1.02 | 978 | 50.7 | 8389 | 3.5 | ⊚(excellent) |
| Example 26b | bal. | 4.03 | 2.96 | 1.02 | 1047 | 50.7 | 8440 | 2.9 | ⊚(excellent) |
| Example 27b | bal. | 5.99 | 3.03 | 1.04 | 1190 | 50.6 | 8544 | 2.6 | ⊚(excellent) |
| Example 28b | bal. | 7.81 | 3.01 | 1.04 | 1535 | 50.4 | 8592 | 2.6 | ⊚(excellent) |
| Comp. Ex. 23b | bal. | 8.22 | 3.03 | 1.05 | 1955 | 50.3 | 8652 | 2.5 | ⊚(excellent) |
| Comp. Ex. 31b | bal. | 0.00 | 4.28 | 0.96 | 696 | 51.1 | 8038 | 44.8 | X (bad) |
| Comp. Ex. 32b | bal. | 0.26 | 4.31 | 0.97 | 712 | 51.1 | 8050 | 43.3 | X (bad) |
| Example 31b | bal. | 0.51 | 4.31 | 0.97 | 729 | 51.0 | 8063 | 9.9 | Δ(fair) |
| Example 32b | bal. | 1.01 | 4.29 | 0.97 | 762 | 51.0 | 8089 | 6.2 | ◯(good) |
| Example 33b | bal. | 1.36 | 4.33 | 0.97 | 786 | 51.0 | 8108 | 4.8 | ⊚(excellent) |
| Example 34b | bal. | 2.00 | 4.28 | 0.98 | 825 | 50.9 | 8138 | 4.0 | ⊚(excellent) |
| Example 35b | bal. | 3.00 | 4.27 | 0.98 | 887 | 50.8 | 8187 | 3.5 | ⊚(excellent) |
| Example 36b | bal. | 3.96 | 4.25 | 0.99 | 950 | 50.8 | 8237 | 3.0 | ⊚(excellent) |
| Example 37b | bal. | 6.03 | 4.25 | 1.00 | 1080 | 50.6 | 8338 | 2.6 | ⊚(excellent) |
| Example 38b | bal. | 7.82 | 4.24 | 1.02 | 1370 | 50.4 | 8402 | 2.5 | ⊚(excellent) |
| Comp. Ex. 33b | bal. | 8.20 | 4.25 | 1.01 | 1774 | 50.3 | 8444 | 2.4 | ⊚(excellent) |
| Comp. Ex. 41b | bal. | 0.00 | 6.49 | 0.85 | 638 | 51.0 | 7127 | 57.1 | X (bad) |
| Comp. Ex. 42b | bal. | 0.21 | 6.52 | 0.85 | 652 | 51.2 | 7138 | 44.1 | X (bad) |
| Example 41b | bal. | 0.50 | 6.50 | 0.85 | 667 | 51.2 | 7150 | 8.9 | Δ(fair) |
| Example 42b | bal. | 1.01 | 6.48 | 0.85 | 698 | 51.1 | 7173 | 5.8 | ◯(good) |
| Example 43b | bal. | 1.42 | 6.54 | 0.86 | 719 | 51.1 | 7189 | 4.9 | ⊚(excellent) |
| Example 44b | bal. | 1.98 | 6.53 | 0.86 | 755 | 51.0 | 7216 | 3.8 | ⊚(excellent) |
| Example 45b | bal. | 2.98 | 6.51 | 0.86 | 812 | 50.9 | 7260 | 3.6 | ⊚(excellent) |
| Example 46b | bal. | 3.97 | 6.46 | 0.87 | 870 | 50.8 | 7304 | 3.4 | ⊚(excellent) |
| Example 47b | bal. | 6.03 | 6.45 | 0.88 | 989 | 50.7 | 7394 | 3.1 | ⊚(excellent) |
| Example 48b | bal. | 7.82 | 6.48 | 0.90 | 1259 | 50.5 | 7446 | 2.8 | ⊚(excellent) |
| Comp. Ex. 43b | bal. | 8.22 | 6.51 | 0.89 | 1625 | 50.4 | 7488 | 2.5 | ⊚(excellent) |
| Comp. Ex. 51a | bal. | 0.00 | 7.39 | 0.84 | 651 | 51.1 | 7020 | 57.9 | X (bad) |
| Comp. Ex. 52a | bal. | 0.23 | 7.40 | 0.84 | 665 | 51.2 | 7031 | 44.3 | X (bad) |
| Example 51a | bal. | 0.50 | 7.39 | 0.84 | 681 | 51.1 | 7043 | 9.2 | Δ(fair) |
| Example 52a | bal. | 1.03 | 7.37 | 0.84 | 712 | 51.1 | 7065 | 7.3 | ◯(good) |
| Example 53a | bal. | 1.40 | 7.44 | 0.84 | 734 | 51.0 | 7081 | 4.8 | ⊚(excellent) |
| Example 54a | bal. | 1.97 | 7.40 | 0.85 | 770 | 51.0 | 7108 | 4.2 | ⊚(excellent) |
| Example 55a | bal. | 2.98 | 7.38 | 0.85 | 829 | 50.9 | 7151 | 3.9 | ⊚(excellent) |
| Example 56a | bal. | 3.97 | 7.39 | 0.86 | 888 | 50.8 | 7194 | 3.5 | ⊚(excellent) |
| Example 57a | bal. | 6.04 | 7.38 | 0.87 | 1009 | 50.7 | 7283 | 3.2 | ⊚(excellent) |
| Example 58a | bal. | 7.82 | 7.39 | 0.89 | 1272 | 50.5 | 7334 | 2.8 | ⊚(excellent) |
| Comp. Ex. 53a | bal. | 8.12 | 7.40 | 0.88 | 1684 | 50.3 | 7375 | 2.8 | ⊚(excellent) |
| Comp. Ex. 61a | bal. | 0.00 | 8.28 | 0.76 | 705 | 51.1 | 6399 | 58.7 | X (bad) |
| Comp. Ex. 62a | bal. | 0.25 | 8.28 | 0.76 | 721 | 51.0 | 6408 | 44.5 | X (bad) |
| Comp. Ex. 63a | bal. | 0.50 | 8.27 | 0.76 | 738 | 51.0 | 6419 | 9.5 | Δ(fair) |
| Comp. Ex. 64a | bal. | 1.04 | 8.26 | 0.77 | 772 | 51.0 | 6440 | 8.8 | Δ(fair) |
| Comp. Ex. 65a | bal. | 1.37 | 8.34 | 0.76 | 796 | 50.9 | 6454 | 7.3 | ◯(good) |
| Comp. Ex. 66a | bal. | 1.96 | 8.27 | 0.77 | 835 | 50.9 | 6479 | 4.6 | ⊚(excellent) |
| Comp. Ex. 67a | bal. | 2.97 | 8.25 | 0.77 | 899 | 50.8 | 6518 | 4.2 | ⊚(excellent) |
| Comp. Ex. 68a | bal. | 3.96 | 8.32 | 0.78 | 963 | 50.7 | 6557 | 3.5 | ⊚(excellent) |
| Comp. Ex. 69a | bal. | 6.05 | 8.31 | 0.79 | 1094 | 50.6 | 6638 | 3.3 | ⊚(excellent) |
| Comp. Ex. 70a | bal. | 7.82 | 8.30 | 0.81 | 1285 | 50.5 | 6684 | 3.2 | ⊚(excellent) |
| Comp. Ex. 71a | bal. | 8.21 | 8.30 | 0.79 | 1797 | 50.3 | 6722 | 3.1 | ⊚(excellent) |

Table 3 shows that the Fe—Co—Si alloys also had a favorable corrosion resistance similarly to Experimental Example 1 when a content of Co and a content of Si were in the above-mentioned ranges. FIG. 1 also shows that when the content of Si was 6.5 mass %, corrosion resistance became more favorable as the content of Co increased. It was also confirmed that magnetic properties were favorable.

Table 4 shows that the dust cores also had favorable corrosion resistance and magnetic properties similarly to the powders in Table 3. FIG. 2 also shows that when the content of Si was 6.5 mass %, corrosion resistance became more favorable as the content of Co increased.

1. A soft magnetic metal powder comprising a plurality of soft magnetic metal particles composed of an Fe—Co based alloy, wherein the Fe—Co based alloy includes:
0.50 mass % or more and 8.00 mass % or less of Co; and
a remaining part composed of Fe and an inevitable impurity.

2. The soft magnetic metal powder according to claim 1, comprising 1.00 mass % or more and 4.00 mass % or less of Co.

3. The soft magnetic metal powder according to claim 1, wherein the Fe—Co based alloy further includes 0.50 mass % or more and 8.00 mass % or less of Si.

4. The soft magnetic metal powder according to claim 2, wherein the Fe—Co based alloy further includes 0.50 mass % or more and 8.00 mass % or less of Si.

5. A dust core composed of the soft magnetic metal powder according to claim 1.
